(19) United States
(12) Patent Application Publication
(10) Pub. No.: US 2018/0207547 A1
(43) Pub. Date: Jul. 26, 2018

(54) Dimple Jacketed Botanical Extraction Vessel

(71) Applicants: Matthew Fisher, Denver, CO (US); Frazier Smith, Savannah, GA (US)

(72) Inventors: Matthew Fisher, Denver, CO (US); Frazier Smith, Savannah, GA (US)

(21) Appl. No.: 15/877,303

(22) Filed: Jan. 22, 2018

Related U.S. Application Data
(60) Provisional application No. 62/448,452, filed on Jan. 20, 2017.

(51) Int. Cl. B01D 11/02

(52) U.S. Cl. CPC B01D 11/0257; B01D 11/0288; C09F 1/00; B01D 2257/70; B01D 2221/00

(57) ABSTRACT

A dimpled jacket botanical extraction vessel contains a quantity of fluid and biological material to extract resin from the biological material. The dimpled jacket botanical extraction vessel includes a fluid tank, a plurality of air inlets, an air relief valve, a resin outlet, and a dimple jacket. The fluid tank is the vessel where the extraction of resin occurs. The plurality of air inlets is connected to the fluid tank to agitate the contents of the fluid tank. The air relief valve maintains the pressure within the fluid tank below a pressure ceiling threshold. The resin outlet is connected to the fluid tank to allow the produced resin to drain from the fluid tank. The dimple jacket maintains an optimal temperature for the contents within the fluid tank to degrade the biological material into resin compounds.

The current application claims a priority to the U.S. Provisional Patent application Ser. No. 62/448,452 filed on Jan. 20, 2017.

### FIELD OF THE INVENTION

The present invention relates generally to an apparatus for a botanical extractor extraction vessel. More specifically, the present invention is a dimpled jacket botanical extraction vessel to rapidly cool the contents of the botanical.

### BACKGROUND OF THE INVENTION

Resin is a substance of plant or synthetic origins that is typically convertible into polymers. Resins have a plurality of applications including, but not limited to, varnishes, adhesives, or glazing agents. Resins are typically synthesized through the use of organic peracids, acetic acid, sulfuric acid, nitric acid, or ion exchange resins to strip the resin from the biological material. These substances increase necessary safety precautions and cost for production of resin. Simplifying the resin production process through the use of water and forced agitation would decrease cost and prompt a safer work environment.

The present invention is a cold-water dimpled jacket botanical extraction vessel. The present invention is implemented in the manufacturing of concentrated resin from botanical material. To produce the resin from botanical material with the present invention, the botanical material is soaked and agitated within the present invention. The present invention is a rounded cylindrical fluid tank that is chilled with a stainless-steel dimple jacket system. Agitation of the biological material is facilitated through the use of a large air compressor or external air source to inject a stream of air through angled air inlets. The angle of the air inlets generates angular momentum of the fluid within the fluid tank due to the stream of air entering the fluid tank. The agitation the biological material degrades the resin glands of the botanical material releasing resin into the fluid tank. The resin is then able to be recovered from the fluid tank through draining the fluid tank.

### BRIEF DESCRIPTION OF THE DRAWINGS

FIG. 1 is a perspective view of the present invention.

FIG. 2 is a front view of the present invention.

FIG. 3 is a rear view of the present invention.

FIG. 4 is a left view of the present invention.

FIG. 5 is a right view of the present invention.

FIG. 6 is a top view of the present invention.

FIG. 7 is a bottom view of the present invention.

FIG. 8 is a cross-sectional view of the present invention along the line A-A from FIG. 6.

### DETAIL DESCRIPTIONS OF THE INVENTION

All illustrations of the drawings are for the purpose of describing selected versions of the present invention and are not intended to limit the scope of the present invention.

The present invention is a dimpled jacket botanical extraction vessel. The present invention implements the use of cold water and forced agitation to degrade botanical material in order to extract resin compounds from the botanical material. These resin compounds are convertible into polymers and have a plurality of applications including, but not limited to, varnishes, adhesives, or glazing agents.

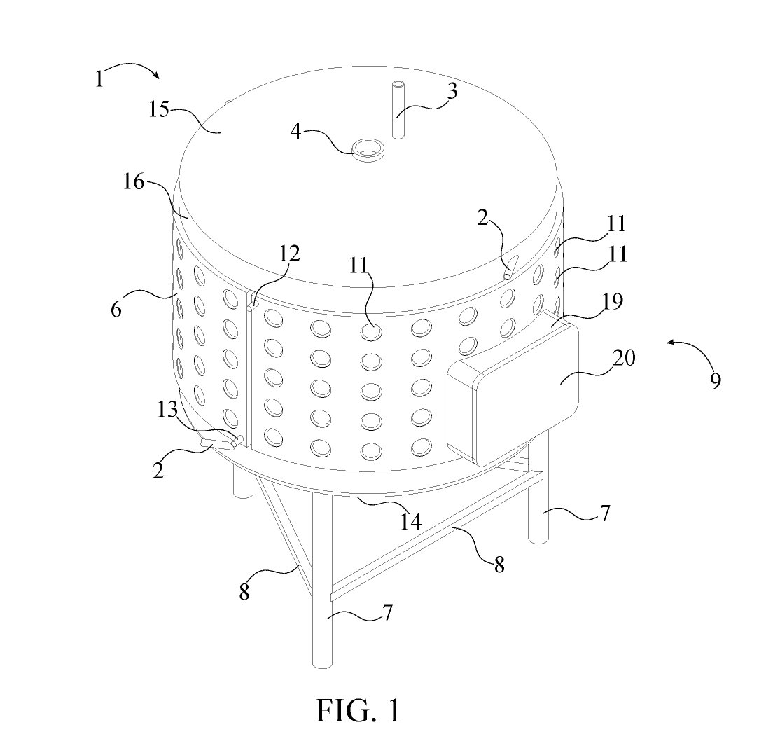

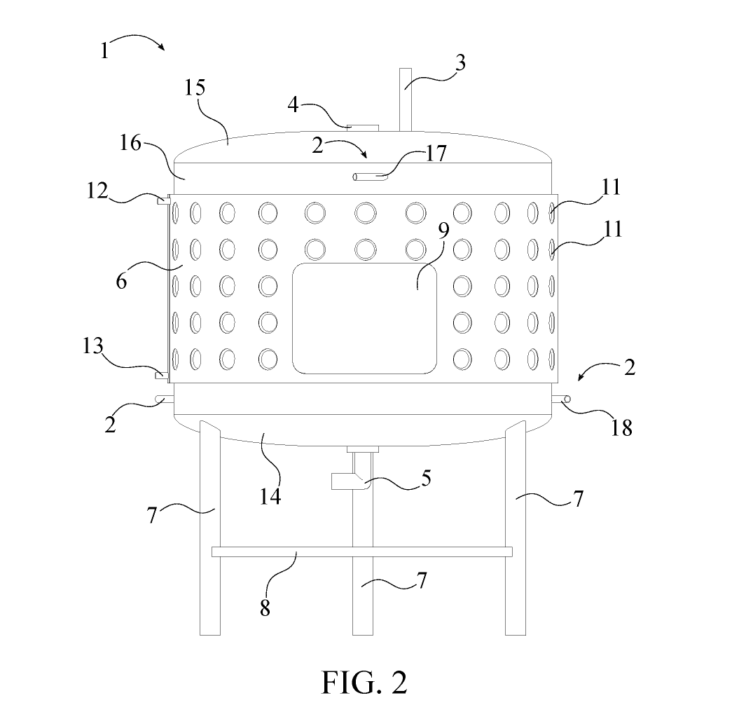

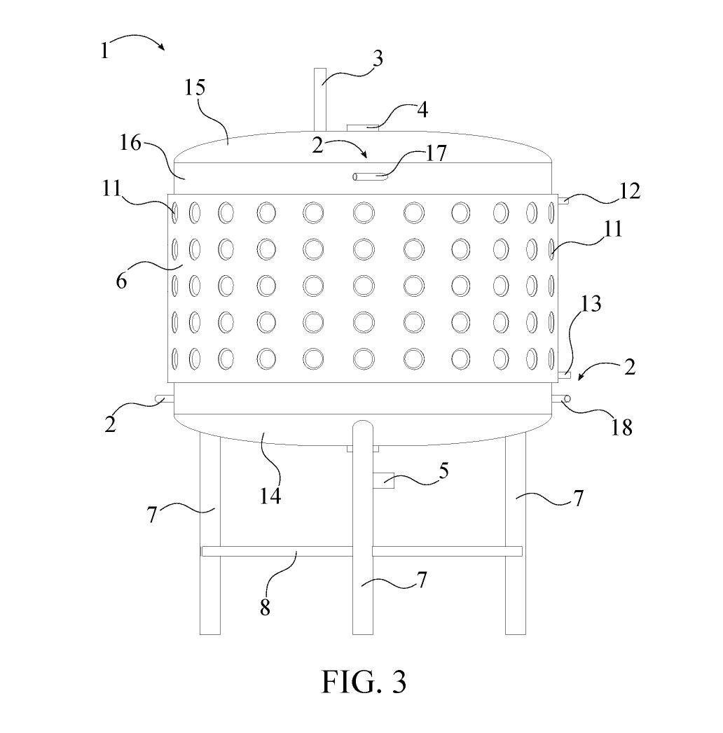

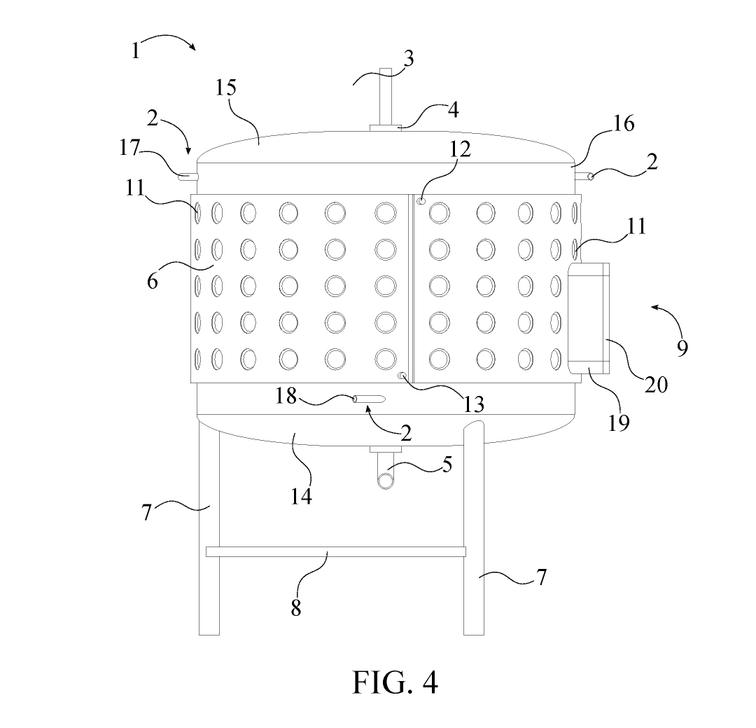

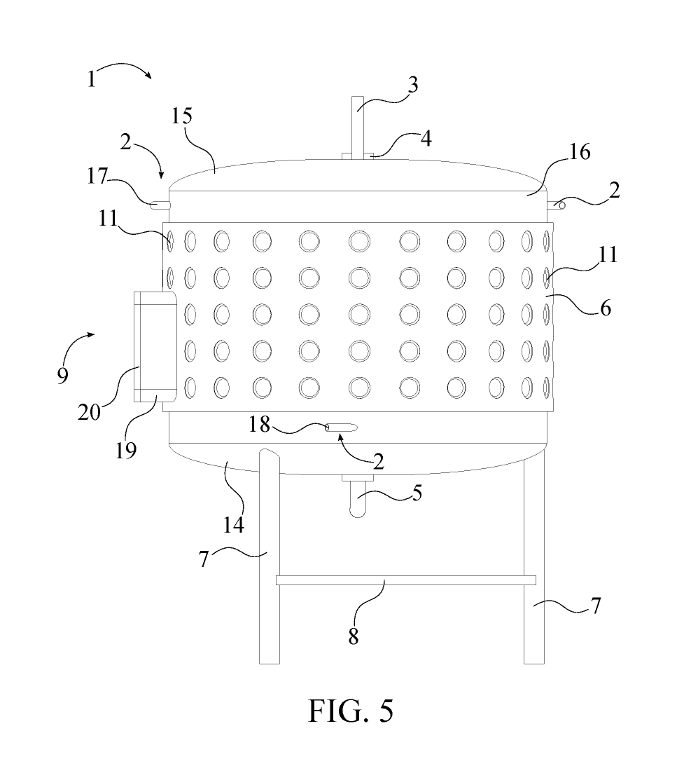

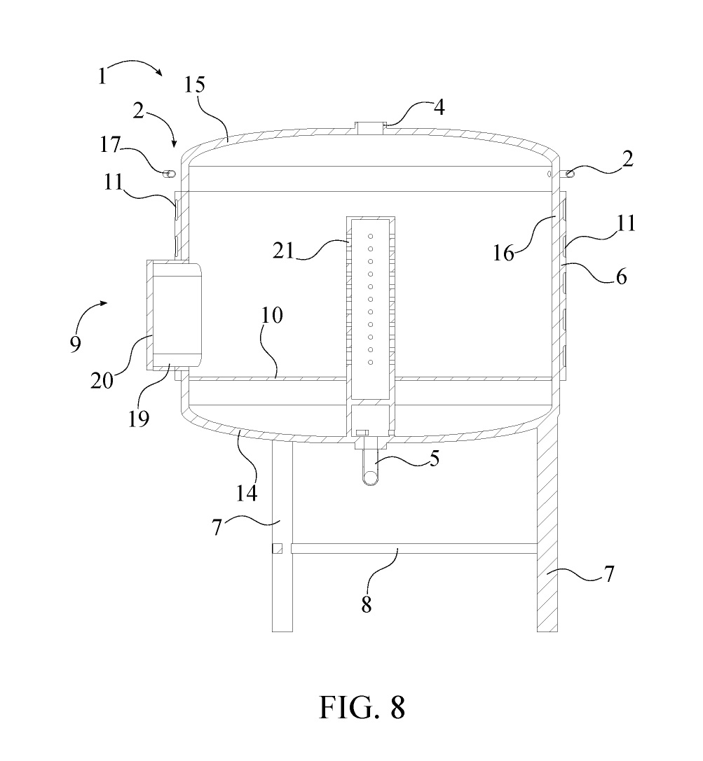

In accordance to FIG. 2, the present invention comprises a fluid tank 1, a plurality of air inlets 2, an air relief valve 3, a fluid-receiving inlet 4, a resin outlet 5, and a dimple jacket 6. The fluid tank 1 is a vessel that contains and controls the fluids and botanical material to extract resin from the botanical material. The fluid tank 1 comprises a tank base 14, a tank cover 15, and a lateral wall 16, shown in FIG. 1 to FIG. 5. The tank base 14, the tank cover 15, and the lateral wall 16 define a reaction volume for the fluid tank 1. The lateral wall 16 is perimetrically connected to the tank base 14. The tank cover 15 is perimetrically connected to the lateral wall 16, opposite to the tank base 14. In accordance to the preferred embodiment for the fluid tank 1, the tank cover 15 has a convex curvature away from the lateral wall 16 into increase the reaction volume within the fluid tank 1. Similarly, the tank base 14 has a convex curvature away from the lateral wall 16 to further increase the reaction volume within the fluid tank 1. The plurality of air inlets 2 allows for forced agitation of the contents within the fluid tank 1. The plurality of air inlets 2 is adjacently and externally connected to the lateral wall 16 to efficiently couple an external air source to facilitate the agitation. The air relief valve 3 is externally connected to the tank cover 15 in order to vent excess air, preventing excessive pressure from building within the fluid tank 1. The fluid-receiving inlet 4 allows the fluid tank 1 to be in fluid communication with an external water or other process fluid source to fill the fluid tank 1, shown in FIG. 1 to FIG. 6 and FIG. 8. The fluid-receiving inlet 4 traverses through the tank cover 15 to allow the fluid tank 1 to be filled with the necessary fluid to extract resin from the botanical material, detailed in FIG. 8. The fluid-receiving inlet 4 is centrally positioned to the tank cover 15. The resin outlet 5 is externally connected to the tank base 14 to allow the fluid and resin compounds within the fluid tank 1 to be drained. The resin outlet 5 is centrally positioned to the tank base 14. The dimple jacket 6 controls the temperature for the contents of the fluid tank 1 to maintain an optimal temperature for the process. The dimple jacket 6 is externally integrated around the lateral wall 16. The dimple jacket 6 is positioned between the tank base 14 and the tank cover 15 to cover significant surface area of the fluid tank 1.

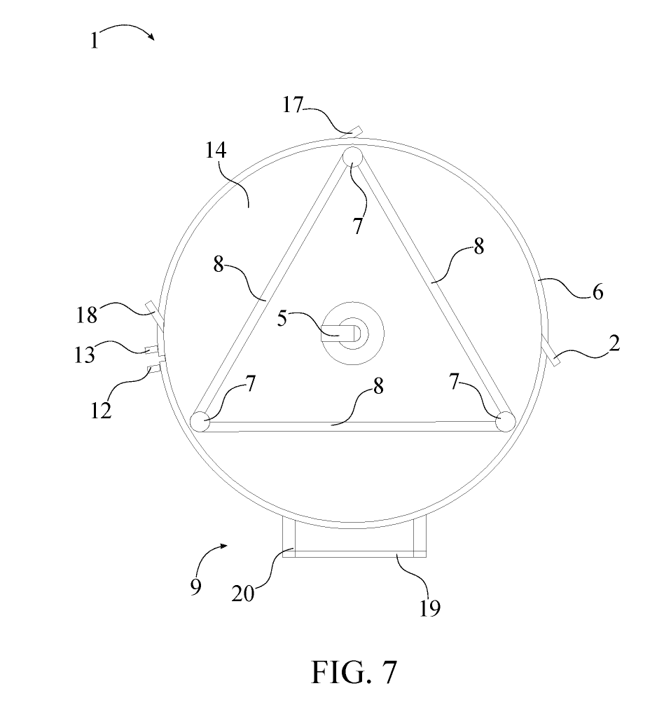

In a more specific embodiment of the present invention, the present invention comprises a plurality of tank supports 7, shown in FIG. 1 to FIG. 5, FIG. 7 and FIG. 8. The plurality of tank supports 7 offsets the fluid tank 1 from a ground surface. The plurality of tank supports 7 is adjacently connected to the tank base 14. The plurality of tank supports 7 is oppositely oriented to the tank cover 15, about the tank base 14 in order to suspend the fluid tank 1 above the ground surface. The plurality of tank supports 7 is evenly distributed about the tank base 14 to distribute and support the weight of the fluid tank 1 and the contents within.

Further, the present invention comprises a plurality of support struts 8, shown in FIG. 1 to FIG. 5, FIG. 7 and FIG. 8. The plurality of support struts 8 prevents lateral deformation of the plurality of tank supports 7. Each of the plurality of support struts 8 is connected between a corresponding pair of tank supports of the plurality of tank supports 7. The plurality of support struts 8 is positioned offset from the tank base 14 to prevent bending of the plurality of tank supports 7.

In accordance to the preferred embodiment of the present invention, the present invention comprises a maintenance access port 9, detailed in FIG. 1 and FIG. 3 to FIG. 8. The maintenance access port 9 allows a technician or operator of the present invention to access the interior of the fluid tank 1 to load botanical material into the fluid tank 1, remove waste produces from the fluid tank 1, or clean the fluid tank 1. The maintenance access port 9 comprises a manhole port 19 and a porthole cover 20. The manhole port 19 allows is an extruded aperture that allows the technician or operator to access the interior of the fluid tank 1. The manhole port 19 is integrated into the lateral wall 16. The manhole port 19 traverses through the dimple jacket 6 to be accessible to the technician or operator. The porthole cover 20 seals the fluid tank 1 while the present invention is implemented to retain fluids within the fluid tank 1. The porthole cover 20 is hingedly connected to the manhole port 19, opposite to the lateral wall 16. The porthole cover 20 perimetrically and selectively engages the manhole port 19 to seal the maintenance port and prevent the contents of the fluid tank 1 from spilling during implementation of the present invention.

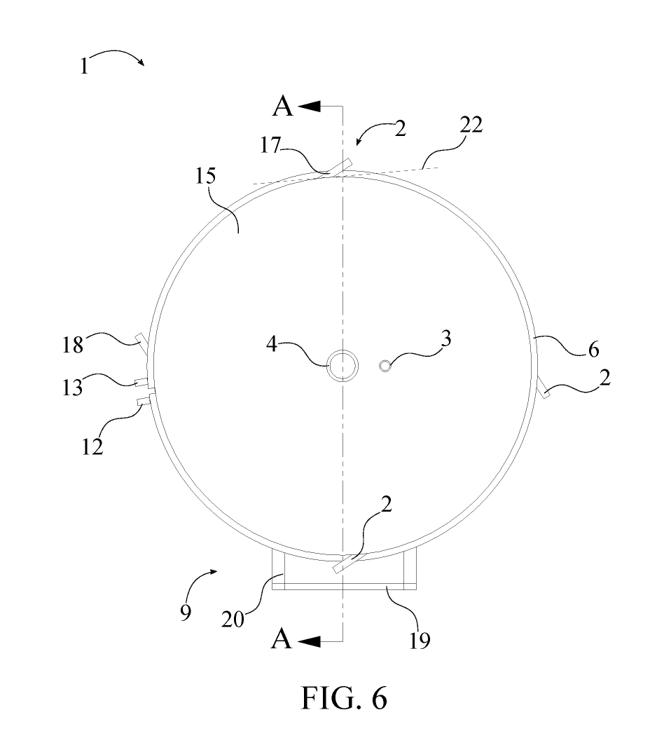

More specific to the preferred embodiment of the present invention, each air inlet is angularly offset from an adjacent tangent 22 to the curvature of the lateral wall 16, detailed in FIG. 6. Each air inlet is preferred to be approximately forty-five degrees from the adjacent tangent 22. This configuration allows for an air stream to enter the fluid tank 1 through each air inlet to impart rotational momentum to the contents of the fluid tank 1. The plurality of air inlets 2 is rotationally symmetric to each other in order to magnify the agitation for the contents of the fluid tank 1.

Further, the plurality of air inlets 2 comprises at least one surface air inlet 17, in accordance to FIG. 2 to FIG. 5 and FIG. 8. The at least one surface air inlet 17 generates a current in the fluid adjacent to the surface of the fluid within the fluid tank 1. The at least one surface air inlet 17 is positioned between the tank cover 15 and the dimple jacket 6 to allow this current to be generated by the external air source.

Additionally, the plurality of air inlets 2 comprises at least one deep air inlet 18, in accordance to FIG. 2 to FIG. 5 and FIG. 8. The at least one deep air inlet 18 generates a current in the fluid adjacent to the tank base 14 within the fluid tank 1. The at least one deep air inlet 18 is positioned between the tank base 14 and the dimple jacket 6 to allow this current to be generated by the external air source. In conjunction with the at least one surface air inlet 17, the at least one deep air inlet 18 generates a whirlpool current to agitate the contents of the fluid tank 1.

In some embodiments of the present invention, the present invention comprises a central agitator 21, detailed in FIG. 8. The central agitator 21 radially agitates the fluid within the fluid tank 1 from the center of the fluid in order to prevent a stagnant region from forming along a central axis of the fluid tank 1. The central agitator 21 is centrally mounted to the tank base 14, within the lateral wall 16. The central agitator 21 is offset from the resin outlet 5 to allow the product stream of resin and waste water to drain out from the fluid tank 1. The central agitator 21 is in fluid communication with the external air source to receive an air stream to agitate the center of the fluid tank 1 to prevent a stagnant region form forming. The air stream radially egresses from the central agitator 21 to force the contents of the fluid tank adjacent to the central agitator 21 into the whirlpool current.

In accordance to the preferred embodiment, the present invention further comprises a filter screen 10, shown in FIG. 8. The filter screen 10 prevents solid waste biological material from entering the product stream. The filter screen 10 is internally and perpendicularly mounted to the lateral wall 16. The filter screen 10 is positioned adjacent to the tank base 14. More specifically, the filter screen 10 is positioned between the tank base 14 and the maintenance access port 9. This configuration for the filter screen 10 allows the operator to fill the fluid tank 1 with biological material, as the filter screen 10 supports the biological material within the fluid tank 1. Additionally, the filter screen 10 prevents the resin outlet 5 from being clogged with waste biological material as the fluid tank 1 is drained. The filter screen 10 is preferred to be modular to allow the technician or operator to disassemble the filter screen 10 to remove or install the filter screen 10 through the maintenance access port 9. The filter screen 10 preferably has a mesh size of approximately 160 microns to prevent large particulates in the fluid tank 1 from being drained through the resin outlet 5.

In some embodiments of the present invention, the present invention the dimple jacket 6 is in fluid communication with a coolant source through a coolant inlet 12, shown in FIG. 1 to FIG. 4, FIG. 6, and FIG. 7. The coolant inlet 12 is adjacently connected to the dimple jacket 6. The coolant inlet 12 is adjacently positioned with the tank cover 15. The coolant stream egresses through a coolant outlet 13 to allow flow through the dimple jacket 6, shown in FIG. 1 to FIG. 4, FIG. 6, and FIG. 7. The coolant outlet 13 is adjacently connected to the dimple jacket 6. The coolant outlet 13 is adjacently positioned with the tank base 14. The coolant source flows into the coolant inlet 12, through the dimple jacket 6 adjacent to the lateral wall 16 to cool the contents of the fluid tank 1, and out from the coolant outlet 13. The coolant is preferred to be selected from a group consisting of ethylene glycol, diethylene glycol, propylene glycol, or combinations thereof. These coolants are chosen due to their favorable heat transfer properties.

To aid in cooling the contents of the fluid tank 1, some embodiments of the present invention comprises a plurality of cooling recesses 11, in accordance to FIG. 1 to FIG. 5 and FIG. 8. The plurality of cooling recesses 11 increases the external surface area of the dimple jacket 6 to increase the rate of heat transfer between the dimple jacket 6 and ambient air. The plurality of cooling recesses 11 is externally integrated into the dimple jacket 6 increasing the surface area. The plurality of cooling recesses 11 is uniformly distributed about the dimple jacket 6 to allows even heat transfer around the dimple jacket 6.

Although the invention has been explained in relation to its preferred embodiment, it is to be understood that many other possible modifications and variations can be made without departing from the spirit and scope of the invention as hereinafter claimed.

What is claimed is:

1. A dimpled jacket botanical extraction vessel comprises:
a fluid tank;
a plurality of air inlets;
an air relief valve;
a fluid-receiving inlet;
a resin outlet;
a dimple jacket;
the fluid tank comprises a tank base, a tank cover, and a lateral wall;
the lateral wall being perimetrically connected to the tank base;
the tank cover being perimetrically connected to the lateral wall, opposite to the tank base;
the plurality of air inlets being adjacently and externally connected to the lateral wall;
the air relief valve being externally connected to the tank cover;
the fluid-receiving inlet traversing through the tank cover;
the fluid-receiving inlet being centrally positioned to the tank cover;
the resin outlet being externally connected to the tank base;
the resin outlet being centrally positioned to the tank base;
the dimple jacket being externally integrated around the lateral wall; and
the dimple jacket being positioned between the tank base and the tank cover.

2. The dimpled jacket botanical extraction vessel, as claimed in claim 1, comprises:
a plurality of tank supports;
the plurality of tank supports being adjacently connected to the tank base;
the plurality of tank supports being oppositely oriented to the tank cover, about the tank base; and
the plurality of tank supports being evenly distributed about the tank base.

3. The dimpled jacket botanical extraction vessel, as claimed in claim 2, comprises:
a plurality of support struts;
each of the plurality of support struts being connected between a corresponding pair of tank supports of the plurality of tank supports; and
the plurality of support struts being positioned offset from the tank base.

4. The dimpled jacket botanical extraction vessel, as claimed in claim 1, comprises:
a maintenance access port;
the maintenance access port comprises a manhole port and a porthole cover;
the manhole port being integrated into the lateral wall;
the manhole port traversing through the dimple jacket;
the porthole cover being hingedly connected to the manhole port, opposite to the lateral wall; and
the porthole cover perimetrically and selectively engaging the manhole port.

5. The dimpled jacket botanical extraction vessel, as claimed in claim 1, comprises:
each air inlet being angularly offset from an adjacent tangent to the curvature of the lateral wall.

6. The dimpled jacket botanical extraction vessel, as claimed in claim 5, wherein each air inlet is oriented approximately 45° from the adjacent tangent.

7. The dimpled jacket botanical extraction vessel, as claimed in claim 1, comprises:
the plurality of air inlets being rotationally symmetric to each other.

8. The dimpled jacket botanical extraction vessel, as claimed in claim 1, comprises:
the plurality of air inlets comprises at least one surface air inlet; and
the at least one surface air inlet being positioned between the tank cover and the dimple jacket.

9. The dimpled jacket botanical extraction vessel, as claimed in claim 1, comprises:
the plurality of air inlets comprises at least one deep air inlet; and
the at least one deep air inlet being positioned between the tank base and the dimple jacket.

10. The dimpled jacket botanical extraction vessel, as claimed in claim 1, comprises:
a filter screen;
the filter screen being internally and perpendicularly mounted to the lateral wall; and
the filter screen being positioned adjacent to the tank base.

11. The dimpled jacket botanical extraction vessel, as claimed in claim 10, wherein the filter screen has a mesh size of 160 microns.

12. The dimpled jacket botanical extraction vessel, as claimed in claim 1, comprises:
a plurality of cooling recesses;
the plurality of cooling recesses being externally integrated into the dimple jacket; and
the plurality of cooling recesses being uniformly distributed about the dimple jacket.

13. The dimpled jacket botanical extraction vessel, as claimed in claim 1, wherein the tank base has a convex curvature away from the lateral wall.

14. The dimpled jacket botanical extraction vessel, as claimed in claim 1, wherein the tank cover has a convex curvature away from the lateral wall.

15. The dimpled jacket botanical extraction vessel, as claimed in claim 1, comprises:
a coolant inlet;
the coolant inlet being adjacently connected to the dimple jacket;
the coolant inlet being adjacently positioned with the tank cover;

16. The dimpled jacket botanical extraction vessel, as claimed in claim 1, comprises:
a coolant outlet;
the coolant outlet being adjacently connected to the dimple jacket; and
the coolant outlet being adjacently positioned with the tank base.

17. The dimpled jacket botanical extraction vessel, as claimed in claim 1, comprises:
a central agitator;
the central agitator being centrally mounted to the tank base, within the lateral wall;
the central agitator being offset from the resin outlet;
